(19) United States
(12) Patent Application Publication
(10) Pub. No.: US 2018/0152125 A1
(43) Pub. Date: May 31, 2018

(54) ELECTRIC WORKING MACHINE

(71) Applicant: MAKITA CORPORATION, Anjo-shi (JP)

(72) Inventor: Kouichi TAKEDA, Anjo-shi (JP)

(73) Assignee: MAKITA CORPORATION, Anjo-shi (JP)

(21) Appl. No.: 15/819,549

(22) Filed: Nov. 21, 2017

(30) Foreign Application Priority Data
Nov. 30, 2016 (JP) 2016-232984

(51) Int. Cl. H02P 6/28; H02P 6/30; A01D 34/78; A01D 34/82; A01D 34/00; A01D 34/68

(52) U.S. Cl. CPC H02P 6/28; H02P 6/30; A01D 34/78; A01D 2101/00; A01D 34/006; A01D 34/6806; A01D 34/824

(57) ABSTRACT

An electric working machine includes a detector configured to detect a specified rotation position of a brushless motor based on an induced voltage, and a controller configured to control current conduction to the brushless motor by setting a commutation timing in response to a detection of the specified rotation position by the detector. The controller disables setting of the commutation timing based on the specified rotation position detected by the detector during a specified mask time from the commutation timing and increases the mask time as a load of the brushless motor is larger.

### CROSS-REFERENCE TO RELATED APPLICATIONS

This application claims the benefit of Japanese Patent Application No. 2016-232984 filed on Nov. 30, 2016 with the Japan Patent Office, the entire disclosure of which is incorporated herein by reference.

### BACKGROUND

The present disclosure relates to an electric working machine provided with a brushless motor as a power source.

To drive a brushless motor, it is necessary to change a current conduction direction in accordance with rotation of the motor. Accordingly, such a brushless motor is usually provided with a rotation sensor to detect a rotation position (an electrical angle) during motor rotation, and a change timing (a change time point) of the current conduction direction, that is, a commutation timing (a commutation time point), is set based on a detection signal from the rotation sensor.

As a driving apparatus of a brushless motor, there is a known sensor-less driving apparatus that detects a rotation position of a brushless motor from an induced voltage generated by motor rotation and drives the motor without using a rotation sensor (see, for example, Patent Document 1: Japanese Unexamined Patent Application Publication No. 2005-176457).

Such a sensor-less driving apparatus avoids the need to provide a rotation sensor to a brushless motor, thereby achieving a simplified configuration and a decrease in size of a brushless motor, as well as high reliability with no risk of failure or disconnection of a rotation sensor.

Accordingly, a sensor-less driving apparatus may be employed as a driving apparatus of a brushless motor in an electric working machine requiring reduction in weight and high reliability.

### SUMMARY

In a sensor-less driving apparatus, as described in Patent Document 1, an induced voltage generated by motor rotation and a reference voltage are compared, and a timing (a time point) at which the induced voltage crosses the reference voltage is detected, to thereby detect a specified rotation position (an electrical angle) of a brushless motor.

An intermediate voltage, which is a variation center voltage of the induced voltage between the maximum and minimum voltage values as the induced voltage varies between a normal direction and a negative direction, is usually used as the reference voltage. By comparing the induced voltage and the reference voltage, a zero cross point of the induced voltage is detected.

The induced voltage varies under the influence of a reflux current that flows after a change of a current conduction direction. Accordingly, it has been conceived to disable rotation position detection during a specified time period from a commutation timing (a commutation time point) to change a current conduction direction in a sensor-less driving apparatus, to thereby avoid misdetection of a rotation position due to voltage variation caused by a reflux current.

However, a time period during which a reflux current flows after interruption of current varies depending on a drive current of a brushless motor. The time period during which the reflux current flows becomes longer as a load applied to the brushless motor is larger and thus the drive current is larger.

Accordingly, if a time period during which rotation position detection is disabled (hereinafter referred to as a “mask time”) is fixed, misdetection of a rotation position might occur due to voltage variation caused by the reflux current during a high-load operation in which the reflux current flows for a longer time.

Also, during a low-load operation in which the reflux current flows for a shorter time, the induced voltage might cross the reference voltage during the mask time, thereby disabling detection of a specified rotation position of the brushless motor.

The present disclosure preferably allows accurate detection of a rotation position without being influenced by a voltage variation caused by a reflux current in an electric working machine including a brushless motor as a power source, while detecting a rotation position (an electrical angle) from an induced voltage and drive-controlling the brushless motor.

An electric working machine in one aspect of the present disclosure includes a brushless motor, a detector configured to detect a specified rotation position of the brushless motor based on an induced voltage generated by a rotation of the brushless motor, and a controller.

The controller is configured to control current conduction to the brushless motor by setting a commutation timing for changing a current conduction direction to the brushless motor in response to a detection of the specified rotation position of the brushless motor by the detector.

Also, the controller disables setting of the commutation timing based on the specified rotation position that is detected by the detector during a specified mask time from the commutation timing and also increases the mask time as a load of the brushless motor is larger.

Thus, according to the electric working machine of the present disclosure, even if the induced voltage varies due to a reflux current that flows after the commutation timing, by setting the mask time, a rotation position can be detected without being influenced by such voltage variation.

The mask time is set to be longer as the load of the brushless motor is larger; thus, the mask time is set corresponding to a time period during which a reflux current flows (in other words, a time period during which position detection cannot be performed properly).

Accordingly, a rotation position can be detected well regardless of whether the load is large and the reflux current flows for a long time or the load is small and the reflux current flows for a short time, and current conduction control can be performed accurately based on the rotation position.

The detector may be configured to compare the induced voltage and a reference voltage for position detection and to detect the specified rotation position of the brushless motor in response to matching of the reference voltage by the induced voltage.

The controller may be configured to detect the load of the brushless motor based on a driving state of the brushless motor or may be configured to detect the load of the brushless motor based on an output state from a battery that supplies drive power to the brushless motor.

Further, in a case of detecting the load of the brushless motor based on the driving state of the brushless motor, the controller may be configured to detect a current flowing in the brushless motor as an indication of the driving state of the brushless motor.

In the case of detecting the load of the brushless motor based on the driving state of the brushless motor, a drive voltage, a rotation speed, a torque, or other measurement than a drive current may be used as an indication. Moreover, as the aforementioned output state from a battery, an output current or an output voltage from the battery may be used.

An electric working machine in another aspect of the present disclosure includes a brushless motor, a detector configured to detect a specified rotation position of the brushless motor based on an induced voltage generated by a rotation of the brushless motor, and a controller. The controller is configured to control current conduction to the brushless motor by setting a commutation timing for changing a current conduction direction to the brushless motor in response to a detection of the specified rotation position by the detector. The controller is further configured to set a mask time, wherein setting the commutation timing is disabled during the mask time, and is further configured to vary the mask time as a function of a load of the brushless motor.

### BRIEF DESCRIPTION OF THE DRAWINGS

One embodiment of the present disclosure will be described hereinafter by way of example with reference to the accompanying drawings, in which:

FIG. 1 is a perspective view showing an external appearance of a grass cutter of the embodiment;

FIG. 2 is a block diagram showing an electrical configuration of the grass cutter of the embodiment;

FIG. 3 is an explanatory diagram showing a drive pattern and changes in phase voltage of a motor;

FIG. 4 is a flowchart showing a position detection process;

FIG. 5 is a flowchart showing a timer process;

FIG. 6A is an explanatory diagram illustrating an operation of the motor during rotation position detection; and

FIG. 6B is an explanatory diagram illustrating an operation of a conventional apparatus.

### DETAILED DESCRIPTION OF THE PREFERRED EMBODIMENTS

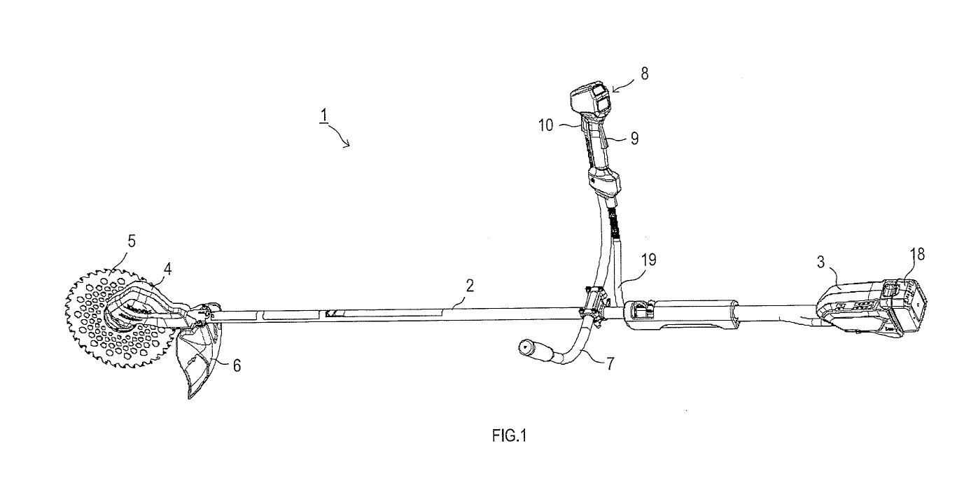

As shown in FIG. 1, a grass cutter 1 of the present embodiment (which may be understood as one example of an electric working machine) includes a main pipe 2, a control unit 3, a drive unit 4, and a handle 7. The main pipe 2 has an elongated and hollow rod shape. The control unit 3 is provided to a rear end of the main pipe 2, and the drive unit 4 is provided to a front end of the main pipe 2.

A rotary blade 5 is detachably and rotatably attached to the drive unit 4. The rotary blade 5 is a blade for cutting a cutting object, such as grass and small diameter trees, and the rotary blade 5 shown in FIG. 1 is a so-called chip saw.

The rotary blade 5 is made of metal and has a disc-shape with saw teeth provided along an entire outer circumference. A hard chip is mounted to a tip of each tooth.

A cover 6 is provided in a front end portion of the main pipe 2. The cover 6 is configured to reduce flying of grass or the like cut by the rotary blade 5 toward an operator of the grass cutter 1.

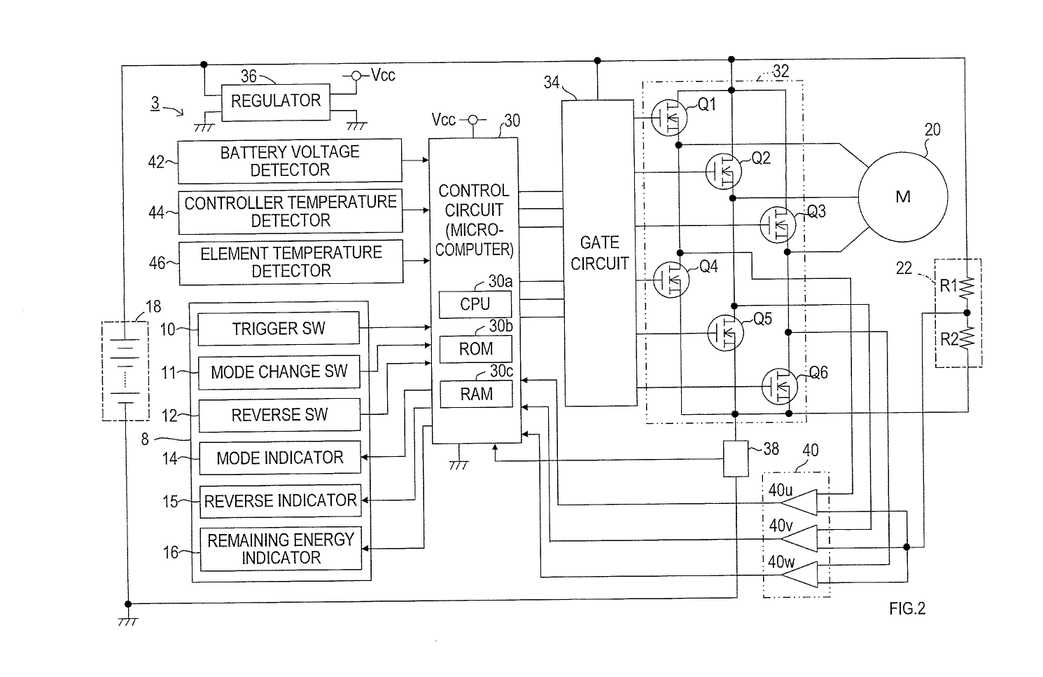

The drive unit 4 houses a motor 20 (see FIG. 2) as a driving source to rotationally drive the rotary blade 5 and a gear mechanism to transmit rotation of the motor 20 to an output shaft. The rotary blade 5 is detachably attached to the output shaft of the drive unit 4.

The motor 20 is a three-phase brushless motor and is drive-controlled by a control circuit 30 (see FIG. 2) in the control unit 3.

The handle 7 is coupled to the main pipe 2 in the vicinity of a longitudinal middle position of the main pipe 2. The handle 7 is a member to be gripped by an operator during grass cutting operation using the grass cutter 1. In the present embodiment, the handle 7 is configured as a so-called U-shaped handle with each end having a grip portion. The handle 7 may be another type of handle, such as a loop handle.

One of the two grip portions of the handle 7 includes an operation and display unit 8 configured to allow an operator to operate by a finger and confirm an operating state.

As shown in FIG. 2, the operation and display unit 8 includes a trigger switch 10, a mode change switch 11, a reverse switch 12, a mode indicator 14, a reverse indicator 15, and a remaining energy indicator 16.

The trigger switch 10 is an operation switch for inputting a drive command of the motor 20. The operation and display unit 8 includes a lock-off switch 9 to make the trigger switch 10 operable (see FIG. 1).

The mode change switch 11 is an operation switch to change a driving speed of the motor 20, for example, among three levels of high, medium, and low. A speed mode (High, Medium, or Low) set by the mode change switch 11 is displayed on the mode indicator 14.

The reverse switch 12 is an operation switch to change a rotation direction of the motor 20 between a normal direction for cutting an object and a reverse direction. Upon a change of the rotation direction of the motor 20 to the reverse direction by the reverse switch 12, the change is displayed on the reverse indicator 15.

As shown in FIG. 1, the remaining energy indicator 16 is configured to indicate a remaining energy of a battery pack 18 (that is, an amount of electric power remaining in a battery in the battery pack 18), which is detachably attached to the control unit 3 and supplies direct current power to the control unit 3.

These components are coupled to the control circuit 30 in the control unit 3 through a cable 19 shown in FIG. 1. The control circuit 30 monitors respective operating states of the switches 10 to 12 and performs driving of the motor 20, setting of the driving speed, changing of the rotation direction of the motor 20, and other functions.

The control circuit 30 also performs indication of operating conditions (a mode indication, a reverse indication, and a remaining energy indication) on the aforementioned indicators 14 to 16 as well as indication of errors on another indicator provided to the operation and display unit 8.

As shown in FIG. 2, the control unit 3 includes a drive circuit 32 and a gate circuit 34 as a driver to deliver current and rotate the motor 20, in addition to the control circuit 30.

The drive circuit 32, which is for receiving power supply from the battery pack 18 (specifically the battery in the battery pack 18) and flowing current to a winding of each phase of the motor 20, is configured as a three-phase full-bridge circuit including six switching elements Q1 to Q6. Each of the switching elements Q1 to Q6 is a MOSFET in the present embodiment.

In the drive circuit 32, the three switching elements Q1 to Q3 are provided as so-called high-side switches between respective terminals U, V, and W of the motor 20 and a power source line coupled to a positive electrode of the battery pack 18.

The remaining three switching elements Q4 to Q6 are provided as so-called low-side switches between the respective terminals U, V, and W of the motor 20 and a ground line coupled to a negative electrode of the battery pack 18.

The gate circuit 34 is configured to turn on/off the switching elements Q1 to Q6 in the drive circuit 32 in accordance with a control signal (in other words, a current conduction command) outputted from the control circuit 30, to thereby flow current to the respective phase windings of the motor 20 and rotate the motor 20.

The control unit 3 includes a regulator 36 that receives power supply from the battery pack 18 and generates a specified power source voltage Vcc (for example, DC 5V) required to operate the control circuit 30, the operation and display unit 8, and the like.

In a path from the drive circuit 32 to the negative electrode of the battery pack 18 in a current conduction path to the motor 20, there is provided a current detection circuit 38 to detect a current that flows to the motor 20. A current detection signal is inputted from the current detection circuit 38 to the control circuit 30.

The control unit 3 also includes a rotation position detector 40 to detect a rotation position of the motor 20 from respective voltages of the terminals U, V, and W of the motor 20, a battery voltage detector 42 to detect a battery voltage, a controller temperature detector 44, and an element temperature detector 46.

Respective detection signals from the detectors 40, 42, 44, and 46 are also inputted to the control circuit 30.

The controller temperature detector 44 is a unit to detect a temperature of the control circuit 30, and the element temperature detector 46 is a unit to detect a temperature of the drive circuit 32 (specifically, the switching elements Q1 to Q6).

The rotation position detector 40 obtains respective induced voltages from the terminals U, V, and W of the motor 20, compares each of the induced voltages with a reference voltage from a reference voltage generator 22, and detects a specified rotation position (electrical angle) of the motor 20 when the induced voltage matches the reference voltage.

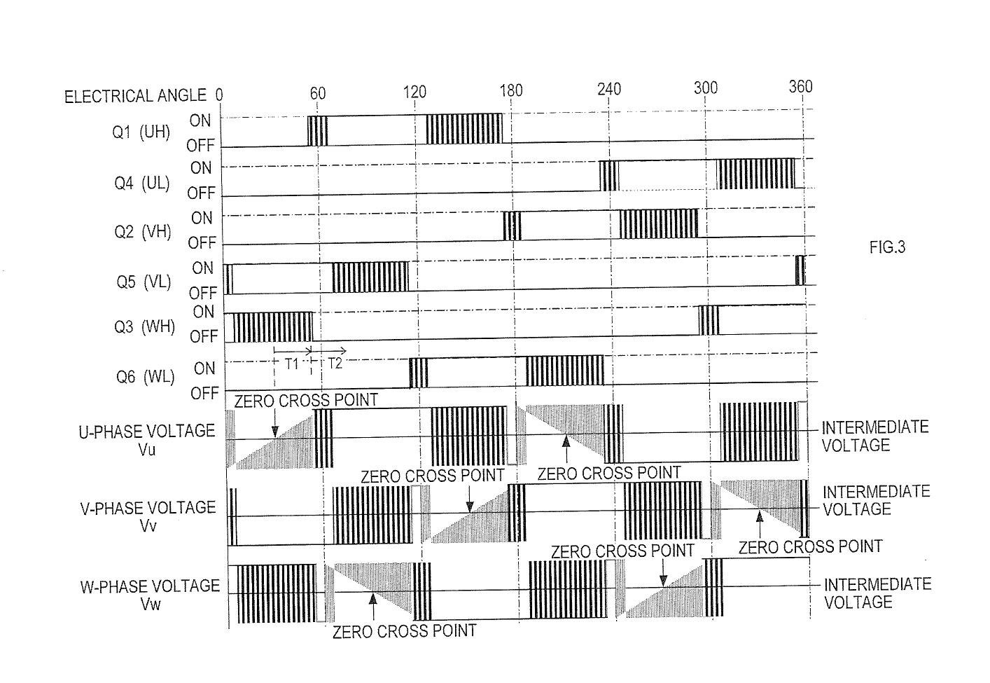

During driving of the motor 20, as exemplarily illustrated in FIG. 3, one of the high-side switches Q1 to Q3 and one of the low-side switches Q4 to Q6 in the drive circuit 32 are sequentially selected for current conduction, and current conduction and a current conduction direction are changed to a corresponding phase winding of the motor 20.

Thus, at each change, one terminal of the three terminals of the motor 20 is brought into an open state, and an induced voltage is generated in the one terminal due to rotation of the motor 20. The induced voltage changes from a positive side to a negative side of the drive circuit 32, or vice versa, and a rotation position of the motor 20 can be identified by detecting a center of the change.

In the present embodiment, a drive voltage applied by the battery pack 18 to the drive circuit 32 is divided in half in the reference voltage generator 22 using voltage dividing resistors R1, R2 having the same resistance value, thereby detecting an intermediate voltage as a variation center voltage of the induced voltage.

Then, the rotation position detector 40 obtains the intermediate voltage detected by the reference voltage generator 22 as a reference voltage and compares the reference voltage with respective voltages Vu, Vv, and Vw of the terminals U, V, and W of the motor 20 using respective comparators 40u, 40v, and 40w.

Accordingly, when an output from the comparator 40u, 40v, or 40w, which compares the induced voltage obtained from the terminal in the open state and the reference voltage, is reversed, it may be determined in the rotation position detector 40 that the induced voltage has passed the reference voltage.

In the present embodiment, it is configured such that a timing (a time point) at which the induced voltage matches the reference voltage is detected as a zero cross point, and the rotation position (electrical angle) of the motor 20 is identified based on the zero cross point. The rotation position detector 40 corresponds to one example of a detector of the present disclosure.

The control circuit 30, which corresponds to one example of a controller of the present disclosure, includes a microcomputer including a CPU 30a, a ROM 30b, a RAM 30c, and other components.

When the trigger switch 10 is operated and a drive command of the motor 20 is inputted, the control circuit 30 delivers current to the motor 20 in a specified current conduction pattern. Then, the motor 20 is initially driven. Subsequently, the control circuit 30 obtains a rotation position and a rotation speed of the motor 20 based on a detection signal from the rotation position detector 40 and drives the motor 20 in a specified rotation direction in accordance with an input from the reverse switch 12.

During driving of the motor 20, the control circuit 30 sets a control amount of the motor 20 such that the rotation speed of the motor 20 becomes a preset driving speed (High, Medium, or Low) depending on the speed mode that is changed by an operation of the mode change switch 11.

The control amount of the motor 20 here is a drive duty ratio of a control signal (PWM signal) that is outputted to the gate circuit 34 in order to turn on/off the switching elements Q1 to Q6 included in the drive circuit 32.

As shown in FIG. 3, the control circuit 30 selects the high-side switch and the low-side switch to be used for current conduction in accordance with a preset current conduction pattern each time the motor 20 rotates by an electrical angle of 60 degrees.

Then, one of the high-side switch and the low-side switch is maintained in an on-state, and the other is turned on/off by the PWM signal, to thereby control the drive duty ratio of the PWM signal such that the rotation speed of the motor 20 becomes a rotation speed corresponding to the speed mode.

In addition to the above-described current conduction control to the motor 20, the control circuit 30 executes an interruption process to set a change timing (a change time point) of the current conduction pattern, that is, a commutation timing (a commutation time point), based on the rotation position of the motor 20 (in other words, based on the zero cross point).

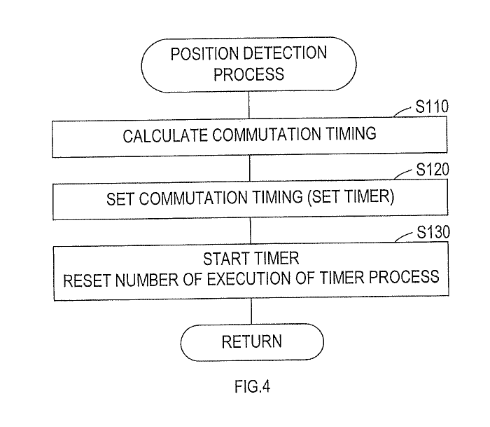

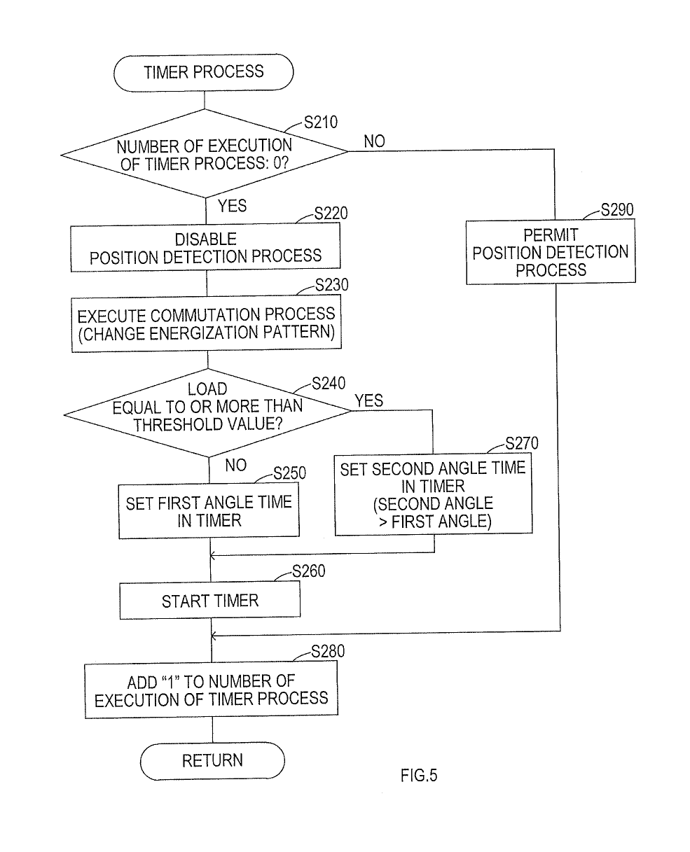

The interruption process is achieved by two processes, that is, a position detection process shown in FIG. 4 and a timer process shown in FIG. 5.

The position detection process is a process to set the commutation timing (the change timing of the current conduction pattern) at a reverse timing (a reverse time point) of the detection signal inputted from the rotation position detector 40 (that is, at the zero cross point).

Thus, the position detection process is started by edges of detection signals from the comparators 40u, 40v, and 40w. The comparators 40u, 40v, and 40w each acquire an induced voltage from the terminal that is not used for current delivery to the motor 20.

In the position detection process, as shown in FIG. 4, calculation of the commutation timing to change the current conduction direction to the motor 20 is first performed in S110 (S denotes “step”), for example, based on the rotation speed of the motor 20 that is obtained from a starting interval of the position detection process.

In subsequent S120, a time T1 (see FIG. 3) from the current time to the commutation timing is set in a timer for time counting so as to “start the later-described timer process at the commutation timing to thereby change the current conduction pattern.” In S130, time counting by the timer is started.

In S130, a counter to count a number of execution of the later-described timer process is reset to thereby set the number of execution to an initial value: “0.” After execution of the process in S130, the position detection process is terminated.

The timer process shown in FIG. 5 is a process that is started when a counting time by the timer has reached a set time. Once the timer process is started it is determined in S210 whether the number of execution of the timer process is “0.”

If the number of execution of the timer process is “0,” which means a timing (a time point) that the time set in the aforementioned position detection process has elapsed, then the position detection process is disabled in S220, and the present process proceeds to S230. In S230, a commutation process to change the current conduction pattern of the motor 20 is executed.

Subsequent to execution of the commutation process in S230, the present process proceeds to S240, in which it is determined whether a load of the motor 20 is equal to or more than a threshold value. In the present embodiment, the determination of the load is performed by determining whether a current value detected by the current detection circuit 38 is equal to or more than a preset threshold value.

If it is determined in S240 that the current value is less than the threshold value, and thus the load of the motor 20 is small, then the present process proceeds to S250. In S250, a first angle time required for the motor 20 to rotate by a preset first angle (for example, an electrical angle of 10 degrees) is set as the counting time by the timer.

If it is determined in S240 that the current value is equal to or more than the threshold value, and thus the load of the motor 20 is large, then the present process proceeds to S270. In S270, a second angle time required for the motor 20 to rotate by a preset second angle (an angle greater than the first angle: for example, an electrical angle of 15 degrees) is set as the counting time by the timer.

The first angle time is calculated in S250 based on the preset first angle and a current rotation speed of the motor 20, and the second angle time is calculated in S270 based on the preset second angle and a current rotation speed of the motor 20.

Subsequent to setting of the counting time in the timer in S250 or S270, the present process proceeds to S260, in which time counting by the timer is started. In subsequent S280, a value “1” is added to the number of execution of the timer process, and then the timer process is terminated.

If it is determined in S210 that the number of execution of the timer process is not “0”, which means a timing (a time point) that a time T2 (see FIG. 3) set in the timer in S250 or S270 has elapsed, then the present process proceeds to S290. In S290, a position detection process is permitted, and then the present process proceeds to S280.

The time T2 set in the timer in S250 or S270 is a mask time (a mask section) to disable execution of the position detection process in FIG. 4.

In the present embodiment, the mask time is changed depending on the load of the motor 20 so as to increase the mask time when the load is large and to decrease the mask time when the load is small, to thereby reduce misdetection of the rotation position due to the detection signal from the rotation position detector 40.

Specifically, as shown in FIG. 3, if the current conduction pattern is changed at the commutation timing at which the time T1 has elapsed from the zero cross point, then a reflux current flows due to energy accumulated in a winding, in which current flow is interrupted, and thereby a voltage to be used for detection of a next zero cross point is changed.

Thus, in the present embodiment, detection of a zero cross point by the position detection process is disabled by the mask time during a time period while a reflux current flows.

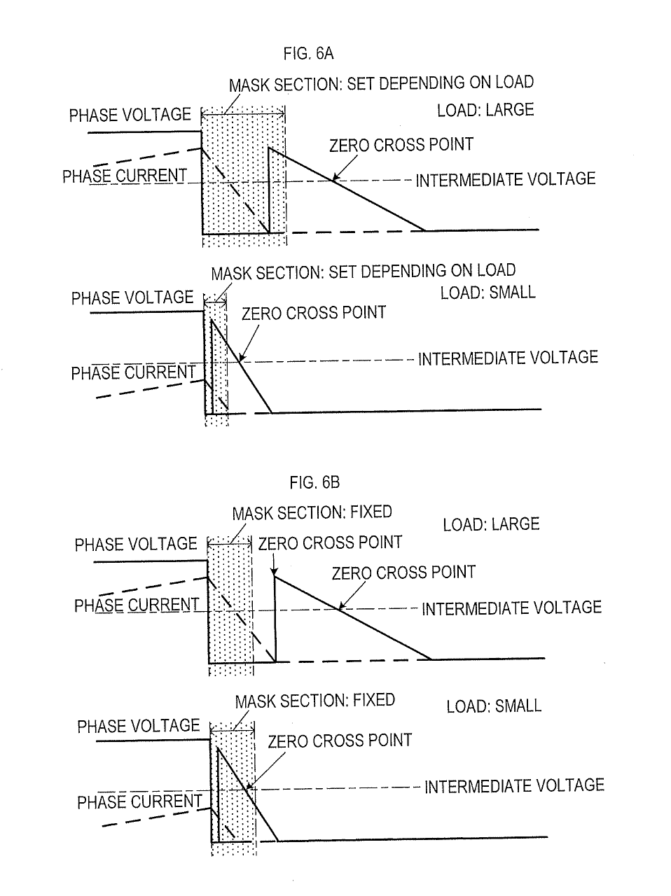

As shown in FIG. 6B, however, in a case where the mask time is fixed, it might occur that if the load is large and a large current flows in the motor 20, then a reflux current flows for a longer time after the commutation, and thus misdetection of the rotation position of the motor 20 is caused after the mask time has elapsed.

Also, it might occur that if the load is small and a small current flows in the motor 20, then a reflux current flows for a shorter time after the commutation, and a zero cross point for identifying the rotation position occurs during the mask time, thereby disabling detection of the rotation position of the motor 20.

In contrast, in the present embodiment, the load is detected from the current flowing in the motor 20 and the mask time is changed depending on the load. Thus, as shown in FIG. 6A, regardless of whether the load is large or small, it is possible to detect the rotation position of the motor 20 from the zero cross point.

Therefore, according to the grass cutter 1 of the present embodiment, it is possible to appropriately set the commutation timing during driving of the motor 20 and to properly control the driving of the motor 20 and thus the rotation of the rotary blade 5.

Although one embodiment of the electric working machine of the present disclosure has been described, the electric working machine of the present disclosure is not limited to the above-described embodiment but may be practiced in various modified forms.

For example, although the mask time is changed between two levels depending on the load of the motor 20 in the above-described embodiment, the mask time may be changed more finely, for example, among three or more levels.

In the above-described embodiment, the mask time is changed by using the current flowing in the motor 20 as the load of the motor 20. However, the mask time may be set in accordance with information related to the load of the motor 20 that is based on the rotation speed of the motor 20, the battery voltage detected by the battery voltage detector 42, or the like.

Increase in the load applied to the motor 20 leads to increase in temperature; thus, it may be configured such that the load of the motor 20 is determined based on the temperature detected by the controller temperature detector 44 or the element temperature detector 46, or on changes in the temperature, and then the mask time is set.

The mask time may be set in accordance with an output state from the battery pack 18 since an output current and an output voltage from the battery pack 18 may vary depending on the load applied to the motor 20.

Also, it may be configured such that the load of the motor 20 is determined by a combination of the aforementioned manners, and then the mask time is set.

Setting of the mask time in these manners may be achieved by changing a parameter to be used for determination of the load in S240 through a similar procedure as in the above-described embodiment.

In the above-described embodiment, the rotation position detector 40 is included as one example of the detector of the present disclosure, and the rotation position detector 40 is configured to compare the respective voltages Vu, Vv, and Vw of the terminals U, V, and W of the motor 20 with the reference voltage by the respective comparators 40u, 40v, and 40w. This function of the rotation position detector 40 may be achieved by a detection process executed by the control circuit 30. Specifically, the function as the detector of the present disclosure may be achieved by inputting the respective voltages Vu, Vv, and Vw of the terminals U, V, and W of the motor 20 to the control circuit 30, generating the reference voltage from the battery voltage in the detection process of the control circuit 30, and comparing each of the voltages Vu, Vv, and Vw with the reference voltage.

In the above-described embodiment, the grass cutter 1 is described as one example of the electric working machine of the present disclosure. However, the electric working machine is not limited to this, but may be any apparatus that includes a brushless motor as a power source.

For example, the technique of the present disclosure may be applied to an electric power tool for masonry work, metalworking, or woodworking, or to a working machine for gardening. More specifically, the technique may be applied to various electric working machines, such as an electric hammer, an electric hammer drill, an electric drill, an electric driver, an electric wrench, an electric grinder, an electric circular saw, an electric reciprocating saw, an electric jigsaw, an electric cutter, an electric chainsaw, an electric plane, an electric nailer (including an electric tacker), an electric hedge trimmer, an electric lawn trimmer, an electric brush cutter, an electric cleaner, an electric blower, an electric sprayer, an electric spreader, and an electric dust collector.

A plurality of functions performed by a single element of the above-described embodiment may be achieved by a plurality of elements, or a function performed by a single element may be achieved by a plurality of elements. Also, a plurality of functions performed by a plurality of elements may be achieved by a single element, or a function performed by a plurality of elements may be achieved by a single element. Further, a part of a configuration of the above-described embodiment may be omitted. Moreover, at least a part of a configuration of the above-described embodiment may be added to, or may replace, other configuration of the above-described embodiment.

What is claimed is:

1. An electric working machine comprising:
a brushless motor;
a detector configured to detect a specified rotation position of the brushless motor based on an induced voltage generated by a rotation of the brushless motor; and
a controller configured to control current conduction to the brushless motor by setting a commutation timing for changing a current conduction direction to the brushless motor in response to a detection of the specified rotation position by the detector, the controller being further configured to disable setting of the commutation timing based on the specified rotation position during a specified mask time from the commutation timing and to increase the mask time as a load of the brushless motor is larger.

2. The electric working machine according to claim 1,
wherein the detector is configured to compare the induced voltage and a reference voltage for position detection and to detect the specified rotation position of the brushless motor in response to matching of the reference voltage by the induced voltage.

3. The electric working machine according to claim 1,
wherein the controller is configured to detect the load of the brushless motor based on a driving state of the brushless motor.

4. The electric working machine according to claim 3,
wherein the controller is configured to detect a current flowing in the brushless motor as an indication of the driving state of the brushless motor.

5. The electric working machine according to claim 1,
wherein the controller is configured to detect the load of the brushless motor based on an output state from a battery that supplies drive power to the brushless motor.

6. An electric working machine comprising:
a brushless motor;
a detector configured to detect a specified rotation position of the brushless motor based on an induced voltage generated by a rotation of the brushless motor; and
a controller configured to control current conduction to the brushless motor by setting a commutation timing for changing a current conduction direction to the brushless motor in response to a detection of the specified rotation position by the detector,
the controller being further configured to set a mask time, wherein setting the commutation timing is disabled during the mask time, and
the controller being further configured to vary the mask time as a function of a load of the brushless motor.
